(19) United States
(12) Patent Application Publication
(10) Pub. No.: US 2010/0318888 A1
(43) Pub. Date: Dec. 16, 2010

(54) SYSTEM AND METHOD FOR PROVIDING SUB-PUBLICATION CONTENT IN AN ELECTRONIC DEVICE

(75) Inventors: William LESHNER, San Diego, CA (US); Brady Duga, Carlsbad, CA (US); Garth Conboy, LaJolla, CA (US); Vincent Le Chevalier, San Jose, CA (US); John Rivlin, Palo Alto, CA (US); Ruze Richards, Holmdel, NJ (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignees: FirstPaper LLC; eBook Technologies, Inc.

(21) Appl. No.: 12/481,705

(22) Filed: Jun. 10, 2009

(51) Int. Cl. G06F 17/00; G06F 3/048; G06Q 30/00

(52) U.S. Cl. 715/202; 715/748; 715/776; 705/14.72

(57) ABSTRACT

A system for and method for providing sub-publication content in an electronic device is presented. The system and method receive electronic content from one or more content sources via a network, where the electronic content includes a master publication content item and one or more sub-publication content items. The system and method store the plurality of electronic content and select at least some of the sub-publication content items for presentation with the master publication content. The system and method present the selected sub-publication content items with the corresponding master publication content at an electronic reader device.

### BACKGROUND INFORMATION

A traditional newspaper is typically printed on paper and allows multiple publication content items (e.g., news items, editorials, reviews, advertisements, etc.) to be effectively shared within newspaper space. Newspaper content is therefore dependently created to fit with other newspaper content for publication. However, as this traditional blend of newspaper content is shifted to newer electronic formats, different publication content items may be created independently. For example, an electronic advertisement may be created independently of an electronic news story publication, both of which may be created by different sources and at different times, but are intended to be presented on the same electronic page. Conventional systems and methods do not provide an efficient technique for displaying independently created sub-publication content in an electronic device.

### BRIEF DESCRIPTION OF THE DRAWINGS

The present invention, together with further objects and advantages, may best be understood by reference to the following description taken in conjunction with the accompanying drawings, in the several figures of which like reference numerals identify like elements.

FIG. 1 depicts a block diagram of a system for content distribution, according to an exemplary embodiment.

FIG. 2 depicts a module for presenting publication content and sub-publication content at an electronic device, according to an exemplary embodiment.

FIG. 3 depicts an illustrative configuration for presenting sub-publication content at an electronic device, according to an exemplary embodiment.

FIGS. 4A-4B depict illustrative configurations for presenting weather forecast sub-publication content at an electronic device, according to an exemplary embodiment.

FIG. 5 depicts an illustrative configuration for presenting sub-publication content with a page-turning feature at an electronic device, according to an exemplary embodiment.

FIG. 6 depicts an illustrative configuration for presenting multiple sub-publication content at an electronic device, according to an exemplary embodiment.

FIG. 7 depicts an illustrative configuration for presenting update sub-publication content at an electronic device, according to an exemplary embodiment.

FIG. 8 depicts an illustrative flowchart for a method of presenting sub-publication content at an electronic device, according to an exemplary embodiment.

### DETAILED DESCRIPTION

Certain embodiments of the present invention provide electronic content access management on an electronic display device. More particularly, certain embodiments of the present invention provide a system for and method of managing electronic content access. Such electronic content may be accessed, by way of non-limiting example, via a device utilizing an electronic paper display (referred to herein as “EPD”), such as electrophoretic displays or electro-wetting displays. Examples of such displays include those disclosed in U.S. Pat. Nos. 6,577,433, 6,529,313, 6,525,866, 6,574,034, 6,017,584, 6,067,185, 6,118,426, 6,120,839, 6,124,851, 6,130,774, 6,172,798, 6,177,921, 6,232,950 and 6,249,271.

In order for an electronic device, such as a reader device, to present content, a sub-publication may be created and used within a master or parent publication. Because various publication content (e.g., news items, editorials, reviews, advertisements, etc.) need to effectively share the electronic newspaper space of the EPD, providing sub-publication content is created independently from the master/parent publication may increase flexibility and efficiency in content delivery.

For example, a sub-publication content (e.g., an advertisement or other publication content) may be created independent of a master publication (e.g., a main news article). The sub-publication content may be referenced by the master publication and may be displayed within a fixed area of the master publication. In some embodiments, the sub-publication may include multiple pages. In other embodiments, the sub-publication may have one or more links and/or other navigation elements that allow a user of the reader device to navigate the sub-publication independent of the master publication. An automatic page turning feature may be implemented for sub-publications having multiple pages of content.

Additionally, in some embodiments, sub-publication content may be device-assembled. For instance, a sub-publication may be presented and/or updated independent of the master or parent publication. In other words, a publication that has been pre-compiled into paginated format may be published with reserve areas for sub-publications that are filled in dynamically by the reader device, for example, as the content document is rendered. Thus, the device may be able to designate one or more sub-publication to a parent publication through the entire distribution system.

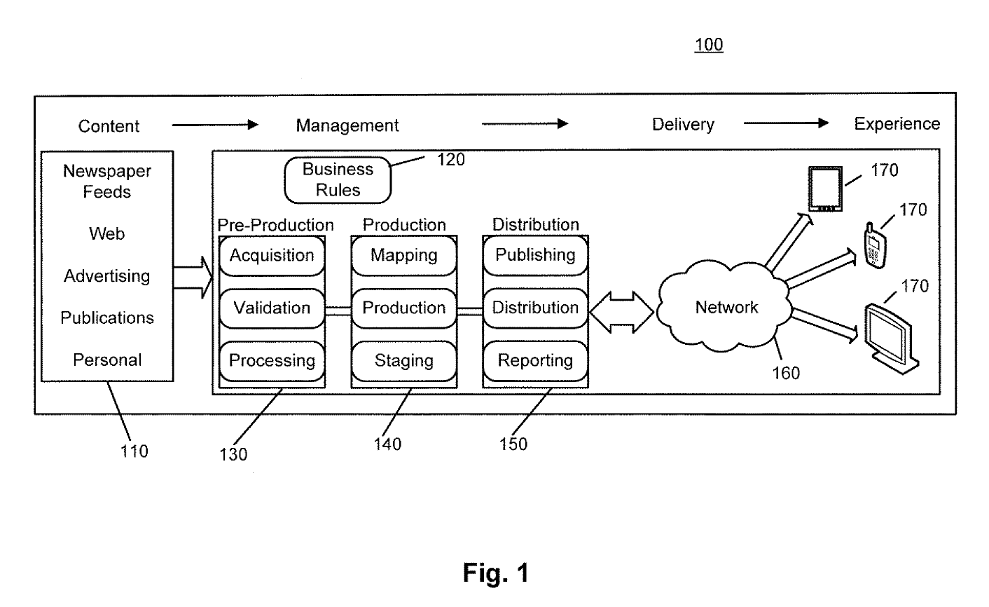

FIG. 1 depicts a block diagram of a system for content distribution, according to an exemplary embodiment. In some embodiments, the system 100 may by a content distribution system (CDN), which may include a content management system 110, a business rules system 120, a pre-production system 130, a production system 140, a distribution system 150 and one or more electronic devices 170. The distribution system 150 may distribute content to the one or more electronic devices 170 over a communications network 160. The communications network 160 may be any wired or wireless network. In one embodiment, the communication network may be an Internet Protocol (IP)-based network.

The content management system 110 may be communicatively coupled to the pre-production system 130, which in turn may be communicatively coupled to the production system 140. The production system 140 may be communicatively coupled to the distribution system 150. In some embodiments, content may be aggregated at the content management system 110 and outputted to the pre-production system 130 for validation and/or processing. The processed content may then be outputted from the pre-production system 130 and received at the production system 140 for mapping and/or staging. The mapped and staged content may then be outputted from the production system 140 and received at the distribution system 150 for publishing and/or distribution to the one or more electronic devices 170 over the communications network 160.

The pre-production system 130 may receive sourced content from the content management system 110 and output processed content to the production system 140. The production system 140 may received the processed content and output staged content to the distribution system 150. The distribution system 150 may receive the staged content and output approved content to one or more of the electronic devices 170.

The content management system 110 may include logic for gathering, aggregating, managing and/or storing content of various types. The types of content may include newspaper feeds, web content, advertising, publications, and/or personal information. In some embodiments, the content management system 110 may be configured to gather and/or aggregate content from one or more sources, categories, and/or content partners to the CDN 100 that provide content in association with the CDN 100. In some embodiments, the content may be gathered and/or aggregated automatically. In other embodiments, the content management system 110 may gather and/or aggregate the content based on one or more criteria. The criteria may include whether the content is perishable, curated, on-line, personal and/or other criteria.

The business rules system 120 may include a workflow engine configured to manage and/or execute modeled business processes. Each step in the operation of the workflow engine may be indicative of one or more business rules. The workflow engine may perform one or more actions based on the one or more business rules indicative of a specific template associated with a feed and/or publication in which content is received at the content management system 110. For example, in some embodiments, the one or more business rules may be completed for each article, publication, and/or advertisement processed through the workflow engine. In various embodiments, the business rules system 120 may include a workflow engine that operates according to one or more of the following rules: content enters the system through the feed; content is stored in a content repository, such as the content management system 110, various validation rules may be executed on the content; various pre-production rules are executed, the results of which may be stored back in the content management system 110; various production rules are executed, the results of which may be stored back in the content management system 110; the distribution system 150 may receive the results of the production system and distribute to electronic devices 170. In one embodiment, the CDN 100 may operate according to an amalgamation of the one or more business rules 120 as applied through the workflow engine.

Information relating to displayed content and/or related user actions may also be used by the business rules system 120 and/or other modules associated with electronic content distribution to enhance content delivery and presentment.

Exemplary content distribution networks are disclosed in U.S. application No. 12/248,482, titled “Systems, Methods and Apparatus for Content Distribution,” filed on Oct. 9, 2008 and U.S. provisional application No. 60/978,748, titled “Content Distribution and Preloading,” filed on Oct. 9, 2007, both of which are hereby incorporated by reference in their entireties.

It should be appreciated that the components/systems of the CDN 100 may be servers, network storage devices or other devices communicatively coupled to the communication network 160. In one or more embodiments, components/systems of the CDN 100 may perform any, or a combination, of storing, receiving, transmitting, producing, aggregating, and/or uploading electronic content. The components/systems of the CDN 100 may also perform other electronic content management functionality including, but not limited to, any, or a combination, of account management, electronic payment processing and verification, target marketing of electronic content to electronic display device users, user electronic content tracking, and content distribution.

In some embodiments, the components/systems of the CDN 100 may contain or be communicatively coupled to storage, such as a redundant array of inexpensive disks (RAID), a storage area network (SAN), an internet small computer systems interface (iSCSI) SAN, a Fibre Channel SAN, a common Internet File System (CFS), network attached storage (NAS), a network file system (NFS), tape drive based storage, or other computer accessible storage.

Additionally, components/systems of the CDN 100 may communicate with any, or a combination, of other systems, applications, and storage locations directly via one or more of an Application Programming Interface (API), a Remote Procedure Call (RPC), an interface table, a web service, an Extensible Markup Language (XML) based interface, a Simple Object Access Protocol (SOAP) based interface, a common request broker architecture (CORBA) based interface, and other interfaces for sending or receiving information. For example, components/systems of the CDN 100 may communicate with accounting systems, marketing systems, interactive voice response (IVR) systems, systems of content providers, or other systems, servers, or components to facilitate electronic content caching and transactions.

Components/systems of the CDN 100 may each be responsible for different functionality in an electronic content distribution network. By way of non-limiting example, the components/systems of the CDN 100 may produce, receive, organize and aggregate electronic content, such as periodicals, books, newsletters, or other electronic content. Such electronic content may be aggregated from one or more feeds, such as publishers, resellers, newspapers, journalists, news services, broadcasts, or other sources. Processing of electronic content may include any, or a combination, of indexing, categorizing, storing, formatting, translating, filtering, spell checking, compressing, encrypting, securing, replicating, and further processing. Electronic content may be produced by user or third-party input (e.g., blogs, newsletters, etc.). Such content may be input via, by way of non-limiting example, typed input or dictations processed by speech to text input (e.g., text of speeches, conferences, proceedings, hearings, etc.). Electronic content may be produced by scanning existing text, such as by way of non-limiting example, by Optical Character Recognition (OCR) processes. Other scanning processes may produce electronic content without performing OCR processes. The components/systems of the CDN 100 may translate content from one format to another. For example, The components/systems of the CDN 100 may receive content from a subscriber and may translate the content into one or more electronic formats including, but not limited to, proprietary formats utilized by one or more e-book readers. The components/systems of the CDN 100 may receive subscriber or user content via emails, FTP (File Transfer Protocol), HTTP (Hyper Text Transfer Protocol), text message (e.g., via Short Message Service (SMS)), Multi-Media Messaging Service (MMS), Wireless Access Protocol (WAP), or via other electronic communication protocols. Categorization of content by the components/systems of the CDN 100 may include any, or a combination, of organizing content, storing content, and indexing content by one or more of a subject, subscription, and access. By way of non-limiting example, content may be grouped or stored in databases or other storage which may be separated according to subscription.

The network 160 may be any network, such as a local area network (LAN), a wide area network (WAN), a service provider network, the Internet, or other similar network. In some embodiments, the network 160 may be a service provider network. It should be appreciated that the network may use electric, electromagnetic, and/or optical signals that carry digital data streams.

The one or more electronic devices 170 may be electronic book (e-book) readers and/or E-Ink® devices. In other embodiments, the one or more electronic devices 170 may be desktop computers, laptops/notebooks, servers or server-like systems, modules, Personal Digital Assistants (PDAs), smart phones, cellular phones, mobile phones, satellite phones, MP3 players, video players, personal media players, personal video recorders (PVR), watches, gaming consoles/devices, navigation devices, televisions, printers, and/or other devices capable of receiving and/or transmitting signals and/or displaying electronic content. It should be appreciated that the network element 102 may be mobile, handheld, or stationary. It should also be appreciated that the one or more electronic devices 170 may be used independently or may be used as an integrated component in another device and/or system.

In some embodiments, electronic display devices 170 may access electronic content locally via one or more device interfaces. For example, the one or more electronic devices 170 may transmit and receive data to and from network 160 utilizing a standard telecommunications protocol or a standard networking protocol. By way of non-limiting example, one embodiment may utilize FTP (File Transfer Protocol), HTTP (Hyper Text Transfer Protocol), Wireless Application Protocol (WAP), Multimedia Messaging Service (MMS), Enhanced Messaging Service (EMS), Short Message Service (SMS), Global System for Mobile Communications (GSM) based systems, Transmission Control Protocol/Internet (TCP/IP) Protocols, or other protocols or systems suitable for transmitting and receiving electronic content data. Electronic content may be transmitted and received wirelessly or may utilize cabled network or telecom connections such as an Ethernet RJ45/Category 5 connection, a fiber connection, a traditional phone wireline connection, a cable connection or other wired network connection. The one or more electronic devices 170 may use standard wireless protocols including IEEE 802.11 and 802.16. The one or more electronic devices 170 may also be connected to network 102 via protocols for a wired connection, such as an IEEE Ethernet 802.3.

By way of non-limiting example, the one or more electronic devices 170 may also contain one or more interfaces including a USB (Universal Serial Bus) connection, an RS-232 or serial connection, a Bluetooth connection, an RFID (Radio Frequency Identification) reader or interrogator, an RFID tag (active or passive), a firewire connection, or interfaces supporting storage media (e.g., flash memory cards, CDs, DVDs). Electronic content may be received by an end user on electronic storage media and may be loaded onto or accessed by an electronic display device via one or more interfaces.

It should also be appreciated that while the components/systems of the CDN 100 are shown as separate components, these may be combined into greater or lesser components to optimize flexibility. For example, while the content management system 110, pre-production system 130, production system 140, and distribution system 150 are depicted as separate components/systems, it should be appreciated that these components/systems may be integrated into a single component. Other various embodiments may also be realized.

It should be appreciated that each of the components/systems of the CDN 100 may be physical and/or virtual servers, modules, storage, devices, systems, etc. Each of the components/systems of the CDN 100 may also communicate with each other via one or more network communications. Other various embodiments may also be provided.

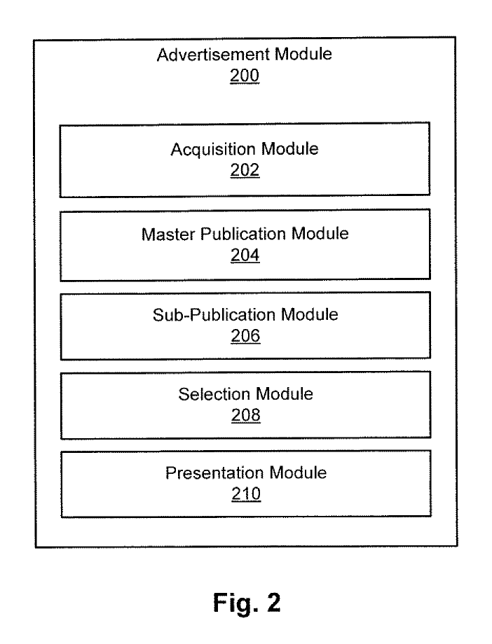

FIG. 2 depicts a module for presenting publication content and sub-publication content at an electronic device, according to an exemplary embodiment. The module may be publication module 200. The publication module 200 may be a part of the content management system 110, the pre-production system 130, the production system 140, the distribution system 150, and/or the one or more electronic devices of the CDN 100. The publication module 200 may implemented in hardware, software, or a combination thereof.

The publication module 200 may include a variety of other components/modules, such as an acquisition module 202, master publication module 204, a sub-publication module 206, a selection module 208, a presentation module 210, and/or other various modules. The acquisition module 202 may receive a plurality of electronic content (e.g., master publication, sub-publication content, etc.) from one or more content sources. The master publication module 204 may store, index, provide, and/or categorize master publication content. The sub-publication module 206 may store, index, provide, and/or categorize sub-publication content. The selection module 208 may select at least some of the plurality of electronic content for presentation (e.g., the master publication with an imbedded sub-publication). The presentation module 210 may present the selected electronic content at an electronic device, wherein the presented electronic content comprises master publication content with sub-publication content.

In some embodiments, implementation of sub-publication content may be spread between mainly two system components. For example, calculation of placement/insertion of the sub-publications and/or pagination of those sub-publications may be performed by the publication module 200 at a content layout engine of system 100. For instance, the publication module 200 may run on one or more servers at the time of content layout compilation. The other system component for implementing the sub-publication content may be at the electronic device 170. In this example, the publication module 200 may run device-based client software to perform various rendering functionalities to present master/parent and sub-publications.

As discussed above, sub-publications may provide the ability to insert one publication inside another publication (e.g., master publication). Both publications may be built using the same software tools and may both be optimized for viewing on a target reading device. The master/parent publication may reserves space on one of its pages for the sub-publication. Sub-publications can be built independently of the parent publication and inserted later by the reading device.

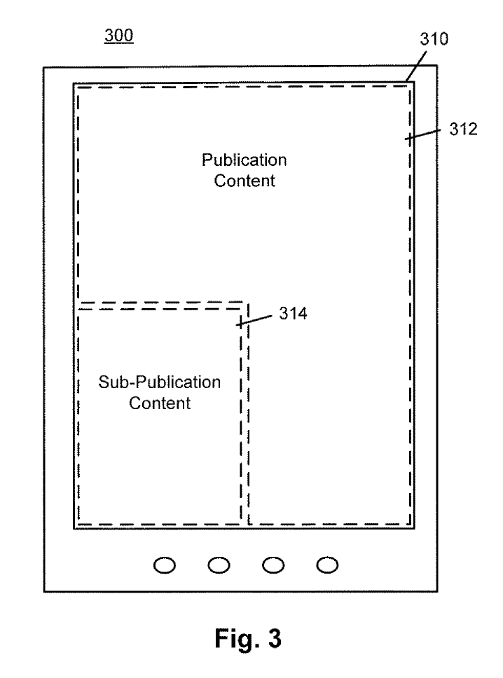

FIG. 3 depicts an illustrative configuration 300 for presenting sub-publication content at an electronic device, according to an exemplary embodiment. For example, the configuration 300 of an electronic device 170 (e.g., an electronic reader device) may have a display area 310 having an area for presenting publication content 312. The display area 310 may also have an area for presenting sub-publication content 314 within the publication content 312. The publication content 312 and sub-publication content may include a variety of content, such as news, editorials, classifieds, advertisements, reviews, etc. Other various embodiments may also be provided.

Software tools to “build” a publication from documents may be authored in an Open Publication Structure format (OPS) that are packaged together according to an Open Packaging Format (OPF). The resulting publication may therefore be specifically designed and optimized for a particular target reading device.

In order to create a sub-publication to be displayed inside of a parent publication, the sub-publication may first be authored in an OPS/OPF format and then packaged as a Open Catalog Format (OCF). The parent publication may be created using the same OPS/OPF format. In some embodiments, size (e.g., width and height) and location of the sub-publication within the parent publication may be controlled through the use of an <object> element. For example:

```
<h1>Report Contradicts Prior Intelligence Assessment</h1>
<p>A new assessment by American intelligence agencies concludes
that Iran halted its
<div class=”ad1”>
  <object type=”application/epub+zip” data=”advertisement.epub”
        width=”200” height=”200”>
    <p>The EPUB format is not supported</p>
  </object>
</div>
nuclear weapons program in 2003 and that the program remains on
hold, contradicting a previous intelligence report.</p>
```

In this example, the “data” property of the <object> element is used to refer to the particular sub-publication file, which may be assumed to be in OCF format (as described above). The <object> element may also specify that the sub-publication is to be rendered at a size of 200 pixels wide and 200 pixels high.

Once the publication content is properly prepared in the correct format, the parent publication may be “built” for a particular device (e.g., reader device) using a software tool designed for that purpose. When the software tool encounters the <object> element that specifies the sub-publication (e.g., “advertisement.epub”), the software tool may search for the OCF file associated with the sub-publication and build the sub-publication automatically into the master publication. In some embodiments, the sub-publication may be automatically built into the master publication according to the width and height specified in the <object> element. The sub-publication may then be stored together with the master/parent publication so that the two may move together as one unit. It should be appreciated that the resulting binary file may be specific to a particular hardware device. It should also be appreciated that this whole operation may be performed automatically by a server or device, without any human or manual intervention.

In some embodiments, master/parent publications that contain sub-publications may have a special index file created for them. These special index files may record the location and/or dimensions of every sub-publication referenced by the parent. As a result, when a reading device renders a page of a parent publication that contains a sub-publication, the special index file may be used to locate an actual file that is to be used to display the sub-publication.

In order to replace a sub-publication in a master/parent publication with a different sub-publication, a new publication may be created using the same software tool used to create the original sub-publication. The new sub-publication may be created with the same dimensions (e.g., the same size) as the original sub-publication. The new sub-publication may then be built just like any other publication. Again, the result may be binary file that targets a particular reading device. Here, the new sub-publication may then be sent to the reading device, possibly over the Internet or other network, where it is stored with other sub-publications. The reading device may, at the discretion of its programming, replace the original sub-publication that already exists for the parent publication with the newly created sub-publication or other sub-publication. In other embodiments, the reading device may keep both old and new publications in storage.

Rendering software in the reading device may render a page of a publication that contains a sub-publication. The rendering software may use the publication's index file to determine which sub-publication to render. For example, as discussed above, the dimensions of the sub-publication, as well as the value of the “data” property of the <object> element in the parent publication or other determining factors, may be used to uniquely identify the sub-publication to be presented. It should be appreciated, however, that the reading device may not be required to use the sub-publication that originally came with the parent. The reading device may choose to use a newly downloaded sub-publication or other sub-publication. In this example, as long as both the original sub-publication and the new sub-publication are intended for the same place in the parent, the reading device may be able to select which sub-publication to insert.

One example for such a sub-publication system may be to implement an advertising system. The location of one or more advertisements to be presented in a master publication may be defined when the master publication is created. The advertisements themselves may be created later. A reading device may have a pool of advertisements stored by the sub-publication module 206 from which it chooses via the selection module 208. Once an advertisement is selected to be displayed within the master publication (e.g., based on size or other factor), the presentation module 210 presented the sub-publication advertisement with the master publication. It should be appreciated that the sub-publication module 206 may update the sub-publication content with new advertisements to keep the entire publication continuously up-to-date.

Although presentment of these electronic content (e.g., advertisements), as described above, may not generally depend on topic/subject a particular user chooses to read/consume, acquiring information relating to displayed electronic content in the master/parent publication may be used to select the sub-publication content. For example, in an advertisement sub-publication example, such information may enhance size, placement, and/or associated costs of advertisements. When electronic content (e.g., an advertisement) is displayed at an electronic device, information relating to the displayed content may be acquired. The information may include time of day/week/year of display, duration of display, geographical location(s) of electronic device during display, location of displayed electronic content on a screen, number of times displayed, and/or any related user actions to the displayed content. It should be appreciated that the related user actions may include clicking a hyperlink, calling the advertiser if device is suitably equipped for making calls, bookmarking the advertisement, forwarding the advertisement to one or more friends, printing the advertisement, etc. This information may be used to determine habits/trends of a user, for example, which may be used to further determine its effectiveness and/or associated price/cost of an advertisement. In some embodiments, this information may be stored and processed by the publication module 200 to determine what advertisements to display and how/where to present them. Although this information may be particular useful for advertisement content, it should be appreciated that other content may also benefit from these features.

Referring back to FIG. 3, the publication content 312 and the sub-publication content 314 may include text, graphics, and/or other content. The publication content 312 and the sub-publication content 314 may also include hyperlinks and/or other interactivity options with which a user to interact. For example, a user may click/touch a hyperlink to retrieve more information about the publication or sub-publication content. In another example, a user may interact with the electronic content by physically printing it out at a printer communicatively coupled to the electronic device. Other various embodiments of content with which a user may interact may also be provided.

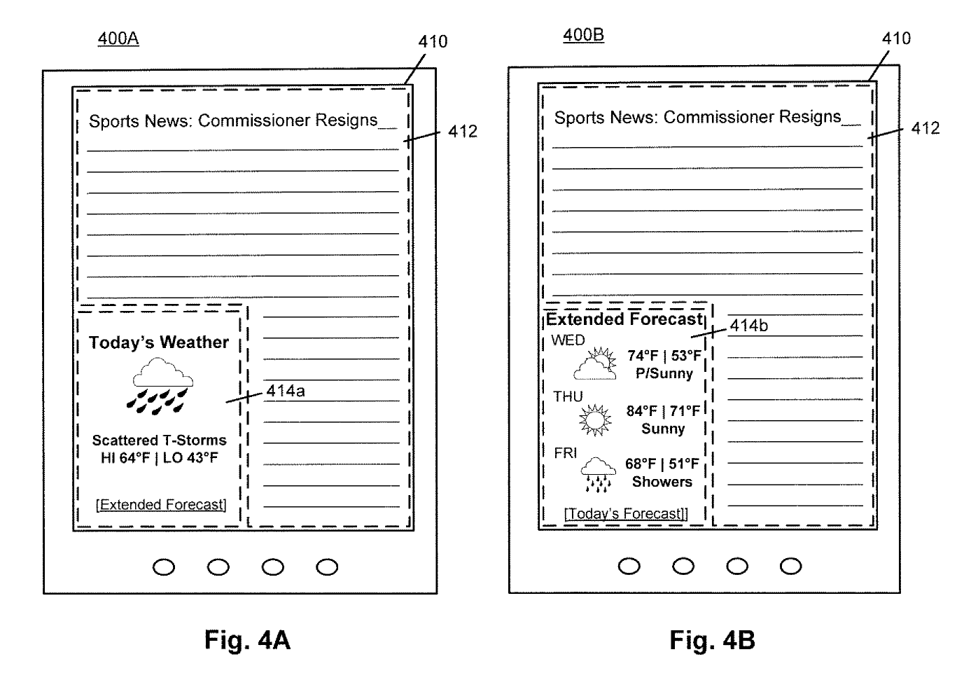

FIGS. 4A-4B depict illustrative configurations 400A, 400B for presenting weather forecast sub-publication content at an electronic device, according to an exemplary embodiment. In FIG. 4A, an electronic device with a display area 410 may be shown. The display area 410 may include publication content 412, such as “Sports News: Commissioner Resigns.” The display area 410 may also include sub-publication content 414a, such as “Today's Weather,” where today's weather may be provided. In this example, text, graphics, and a hyperlink may be provided in the sub-publication 414a. For instance, in addition to detailing today's weather and providing a pictorial image of the weather, a hyperlink for “Extended Forecast” may be provided for user interactivity. In this example, user interaction with a contained sub-publication may occur entirely within the area occupied by the contained sub-publication. Thus, if a user clicks on the “Extended Forecast” link within the sub-publication, the destination may be displayed within the sub-publication display area 414a.

FIG. 4B depicts the electronic device with a display area 410 after the hyperlink is selected. Here, the sub-publication in the lower left-hand corner may be altered or updated altered to display the extended forecast sub-publication 414b. For instance, the extended forecast sub-publication 414b now presents the weather for Wednesday, Thursday, and Friday, using text, pictorial images, and/or other types of content. Similar to FIG. 4A, a hyperlink may also be provided. In this example, the sub-publication 414b may have a “Today's Forecast” hyperlink with which a user may select to go back to the original sub-publication of today's weather forecast.

While FIGS. 4A-4B may provide a simple example of how sub-publications may be used, it should be appreciated that a variety of other applications and implements may be provided to enrich user interaction, display quality, and/or other benefits.

For example, some applications of sub-publications may require the use of links that are able to navigate to content in the containing document. To facilitate this kind of linking, a special link type will be introduced that allows references to the containing document of a sub-publication.

This link from the sub-publication may be specified using the following syntax:

<a href=“parent://#target”>Tap here for details</a>

It should be appreciated that because sub-publications are complete OCF publications in and of themselves, a sub-publication containing additional embedded sub-publications may also be provided. Therefore, it may be possible to have a sub-publication with sub-sub-publication, and so on, to an infinite degree.

Frames are specified in HTML using <frame> or <iframe> tags and the source content of a frame may appear directly in the same HTML document, or be included via a link. A sub-publication system, however, as described herein may be advantageous over HTML frames because sub-publications are optimized for a reading systems (e.g., in reader devices) while HTML frames are not. For example, even a low-powered reading system may be more efficient and provide better rendering of a sub-publication than it will using an HTML frame.

Because a reading system is free to choose one or more sub-publications from a list of possible sub-publications to display when displaying the master/parent publication, software on used by the reading system may not be required to communicate with server-side components at the time of display. For example, software plugins are typically used for the display of rich content not supported directly by a browser itself. Therefore, creators of HTML documents may specify where and at what dimensions plugin-rendered content is to be used in a document, Browsers are then responsible for invoking the appropriate plugin when the document is being displayed, and the plugin itself is responsible for displaying its own particular content.

Providing a sub-publication is advantageous over a plugin system because a plugin is itself a piece of software that needs to be installed and kept up-to-date. Sub-publications are rendered with the same software with which the master/parent publication is rendered. As a result, no additional software is needed to display a sub-publication. Furthermore, the fact that sub-publications and their master/parent publication content are both rendered using the same rendering engine, a level of cooperation between the two publication types is provides, which is something that is much more difficult to attain in typical plugin system.

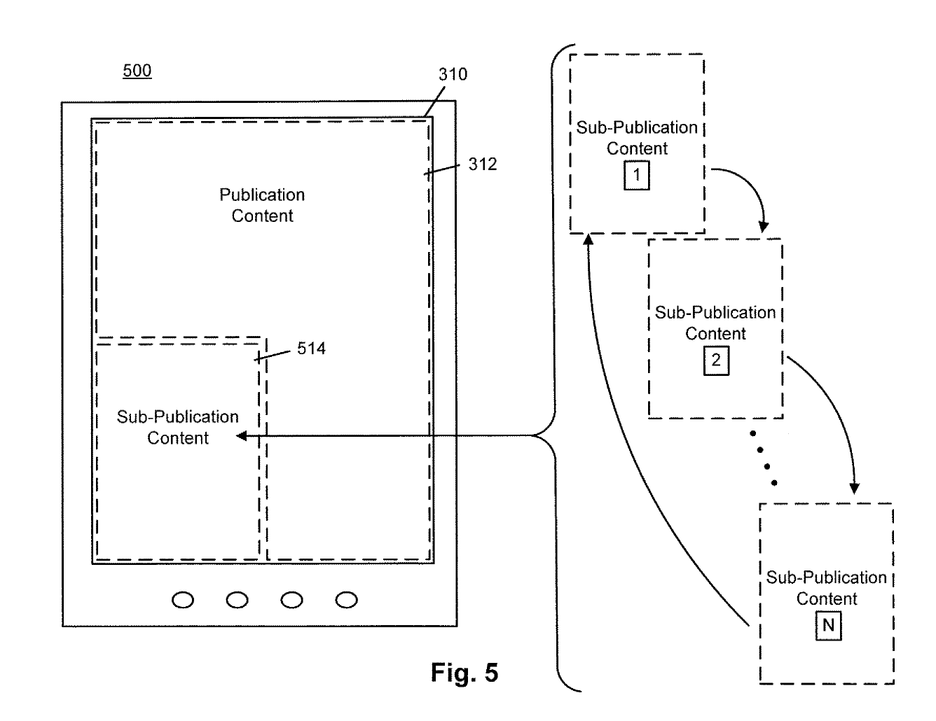

FIG. 5 depicts an illustrative configuration 500 for presenting sub-publication content with a page-turning feature at an electronic device, according to an exemplary embodiment. As discussed above, sub-publications may provide the ability to insert one publication inside another publication. In this example, an auto-page turning feature for sub-publications may provide the provide sub-publication to be viewed similar to that of a slideshow, where pages of the sub-publication may automatically change without any need to for user interaction.

Similar to FIG. 3, FIG. 5 depicts an electronic device with a display area 310 and an area for publication content 312 (e.g., master publication). However, the configuration 500 of FIG. 5 provides sub-publication content 514 with an auto-page turning feature. In this example, a sub-publication may have N pages and the area for sub-publication presentation may display each of these sub-publication pages. In some embodiments, the sub-publication pages may be presented in sequential order, e.g., page 1, page, 2, . . . ,page N. The auto-page turning feature may be set at a predetermined time interval (e.g., two (2) seconds, etc.). Such a feature may create much richer layout possibilities for a full publication.

In order to create a sub-publication to be displayed inside of a master/parent publication, the sub-publication may be authored in the OPS/OPF format and then packaged as an OCF, where the master/parent publication is also created using the same OPS/OPF format, as discussed above. By default, sub-publications may not turn their pages automatically. In order to facilitate page turning, a content creator may provide page turning links in the sub-publication for the user to use to turn the page. In other embodiments, reading devices (e.g., at the publication module 200) may also provide ways to turn the pages of sub-publications.

In order to enable automatic page turning in a sub-publication, one or more parameters may be specified on the <object> element used to embed a sub-publication in a parent. Two parameters that may be used to control automatic page turning are “auto-page-turn-delay” and “auto-page-turn-loops.” The “auto-page-turn-loops” parameter may specify, in centiseconds, for example, the delay between page turns. The “auto-page-turn-loops” may specify whether automatic page turning should stop upon reaching the last page of the sub-publication. In some embodiments, a loop back to the first page of the sub-publication may be set as a default behavior when a final page of the sub-publication is reached.

In order to turn auto-page turning on using the above example, the following <object> element may be used:

```
<object type=”application/epub+zip” data=”advertisement.epub”
        width=”200” height=”200”>
    <param name=“auto-page-turn-delay” value=“100” />
</object>
```

In this example, setting the “auto-page-turn-delay” parameter to “100” may causes auto-page turning to be turned on, with a page turn delay of 100 centiseconds (or 1 second). By default, when the sub-publication turns its last page, it may automatically loop around to its first page. To turn that behavior off, the “auto-page-turn-loops” parameter may need to be set to “no,” as shown below:

```
<object type=”application/epub+zip” data=”advertisement.epub”
        width=”200” height=”200”>
    <param name=“auto-page-turn-delay” value=“100” />
    <param name=”auto-page-turn-loops” value=”no” />
</object>
```

The sub-publication resulting from the <object> element shown above may automatically turn pages of a multi-page sub-publication with a 1-second delay between turns, and it will stop turning pages upon reaching its last page. Other various embodiments may also be provided.

Although animated GIFs appear to provide a functionality that is similar to sub-publications with auto-page turning, sub-publications may provide a much richer set of layout features and may also able to interact with their parent, in ways that animated GIFs cannot. Furthermore, the fact that sub-publications may be authored with the same tools used to author master/parent publications, no additional software is needed to create sub-publications that turn pages automatically, making sub-publications a much more efficient and reliable alternative, particularly in electronic reader devices.

While embodiments describe above have described primarily using one sub-publication embedded within a master-parent publication, it should be appreciated that multiple sub-publications may be embedded within a master/parent publication.

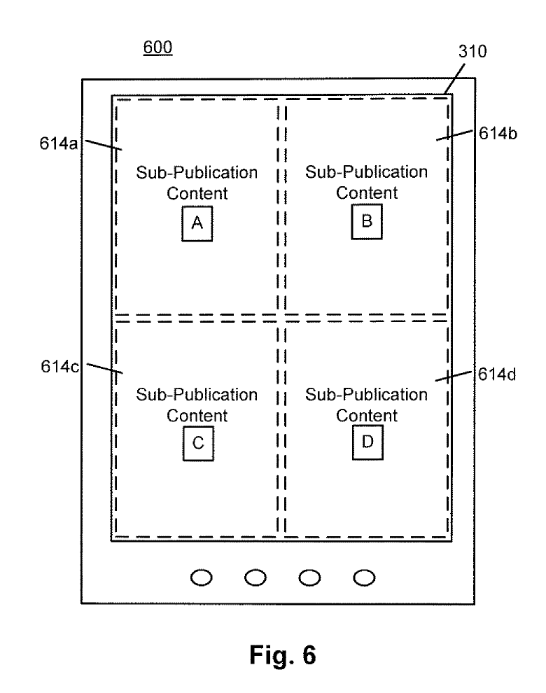

FIG. 6 depicts an illustrative configuration 600 for presenting multiple sub-publication content at an electronic device, according to an exemplary embodiment. In this example, the display area 310 may include a master publication that does not have any content other than sub-publications. For instance, configuration 600 includes four (4) sub-publications: sub-publication content A 614a, sub-publication content B 614b, sub-publication content C 614c, and sub-publication content D 614d. Such a configuration may allow the entire publication to be more dynamic and may provide much richer layout possibilities, as well as flexibility, for a full publication.

It should also be appreciated that while only four (4) sub-publications are being displayed in the configuration 600 of FIG. 6, a greater or lesser number of sub-publications may also be provided.

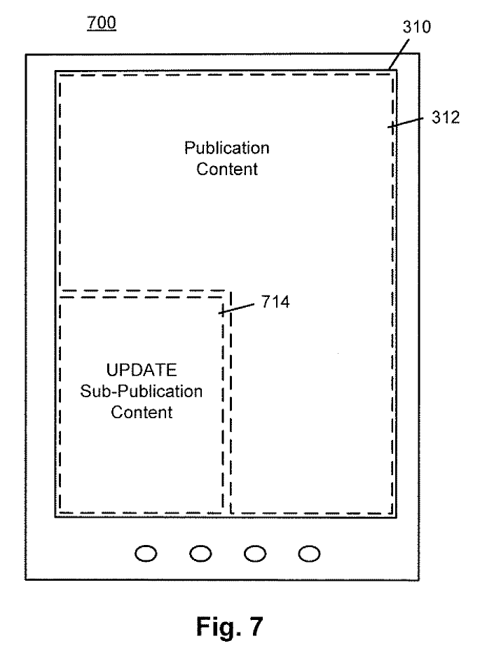

FIG. 7 depicts an illustrative configuration for presenting update sub-publication content at an electronic device, according to an exemplary embodiment. Similar to FIG. 3, FIG. 7 depicts an electronic device with a display area 310 and an area for publication content 312 (e.g., master publication). However, the configuration 700 of FIG. 7 may provide an update sub-publication content 714.

As discussed in previous embodiments above, sub-publications may be external to the master/parent publication and may be updated independently of the master/parent publication. For example, a publication that has been pre-compiled into paginated format may be allowed to reserve areas for sub-publications that are filled in dynamically as the content document is rendered, likely on reading device. Thus, sub-publications may be tied to a parent publication through the entire distribution system.

However, a sub-publication may be replaced and/or updated without replacing the entire publication. For example, a new “breaking news” sub-publication may be placed and updated on a page, or an advertisement sub-publication may be continuously updated in the sub-publication content 714 area. In other words, a sub-publication may be “dynamic” without expending the bandwidth required to replace the entire publication, e.g., by communicating with servers and other network components for publication updates, etc.

Prior to this feature, it should be noted there was no way to update a portion of a publication without replacing the entire publication. As a result, all updates require an entire edition to be transmitted to the device. Use of update sub-publications may provide the ability for one fully assembled publication to reference and/or incorporate another external publication resident on the electronic device without replacing the entire publication.

It should be appreciated that in some embodiments, it is presumed that a referenced sub-publication will fit within the specified sub-publication content area. However, in the event that the sub-publication does not fit exactly in the area specified, in some embodiments, the update sub-publication may be scaled to fit. As a result, it may be important to build parent publications with specific size dimensions to fit and inserted sub-publications with matching sizes.

In order to achieve the end-to-end delivery of these device assembled publication update sub-publications, it may be necessary to make a number of modifications to delivery system as well as how publications are handled on the device. For example, the concept of a publication update that is tied to parent publication that it is intended to be viewed within may be provided.

In order to create a publication that contains updates, a parent publication may be created with a reference and all referenced sub-publications may also be created.

To create a parent publication that references an update sub-publication, a reference in the parent publication with an enhanced sub-publication reference may be created. A sample syntax may be as follows:

```
<object class=“bordered” type=“application/epub+zip”
        data=“NYT20080120.epub”
        width=“220” height=“250”>
      <param name=“open-id” value=“id-from-content” />
</object>
```

In this example, “NYT20080120.epub” may be an update sub-publication, which may be available to replace the initially included sub-publication and that the update sub-publication should be preferred at display time on the device.

When the update sub-publication is rendered it will be automatically opened on the page containing the “open-id” value of “id-from-content.” This may allow multiple update sub-publications to be placed in a single pre-paginated file if there is no navigation provided within the update sub-publication.

In order to build an updateable publication, documents for each of the referenced update sub-publications may be created. This may be accomplished by creating update sub-publications paginated to the exact size of the reserved “hole” in the parent publication. The result may be a pre-paginated file containing a sub-publication that fits perfectly in the area describe by the object tag from the master/parent publication.

Then, any update sub-publications may be attached to the parent publication as it is submitted to the delivery system.

Update sub-publications may differ from normal (complete) publications in that they may not appear as separate, stand-alone documents on a user's device, (e.g., on a user's Online Bookshelf, etc.). They may not even be independently viewable on the user's device. In fact, each update sub-publication may be tied to a master/parent publication and may be displayed solely within that master/parent publication.

To associate an update sub-publication with a parent publication when the update sub-publication is being submitted to the Online Bookstore, for example, in pre-compiled paginated format, an additional extensible markup language (XML) element indicating the “book id” of the referencing parent publication may be required in the XML file accompanying the pre-paginated update sub-publication. The XML file may appear as follows:

<?xml version=“1.0”?>
<Book Action=“Create”>
<ReferencedBy>NYT:20080701</ReferencedBy>
</Book>

In this example, the <ReferencedBy> element may indicate to the Online Bookstore that the update sub-publication should be attached to the specified “ReferencedBy” master/parent publication. Note that any number of update sub-publications may be associated with a particular parent publication.

If an update sub-publication is supplied with the same “book id” as an existing publication, then the new update sub-publication may be distributed and replace any existing update sub-publications with the same “book id.”

When update sub-publications are pushed, for example, from an Online Bookstore to network services, the update sub-publications may be associated with a master/parent publication that references them. This may be accomplished by the new “ReferencedBy” property of the Express API that connects the Online Bookstore with the network services.

It should be appreciated that association of update sub-publications with master/parent publications may accomplish several items. First, publications that have been associated with other publications may not display as independent documents on the Online Bookshelf (e.g., Online Newsstand). Second, publications that have been associated with other publications may not displayed as independent documents on the local eBookshelf (e.g., eNewsstand). Third, when a parent publication is removed from the Online Bookshelf (Online Newsstand), all update sub-publications referenced by the parent publication may also be automatically be removed from the Online Bookshelf. Lastly, when a parent publication is removed from the local eBookshelf, all update sub-publications referenced by the parent publication may also be automatically removed from the eBookshelf.

It should also be appreciated that update sub-publications may be downloaded to a device as a result of an “Update Now” operation, e.g., by syncing a client with a server. This may occur as a result of user request (e.g., where a user selects an “Update Now” menu item choice), by timer that periodically updates, or other similar updating feature.

When update sub-publications are downloaded to an electronic reader device, they may be identified to the device by a special “ReferencedBy” cookie, for example, that may identify a parent publication to which the update sub-publications are referenced. This special cookie may allow the electronic device to identify the parent publication with which the update sub-publication should be attached to (e.g., stored inside the parent publication in local storage).

Update sub-publications may occur where a parent publication references them. Otherwise, for all general purposes, update sub-publication may remain invisible to a user. When a master/parent publication renders an update sub-publication, it may select the zoom state for the update sub-publication that is currently active in the parent publication. This may allow the master/parent publication and all referenced update sub-publications to appear as a single integrated publication. If a parent publication is displayed and the referenced update sub-publication is not yet present on the device, the sub-publication that was built with the parent publication may be displayed.

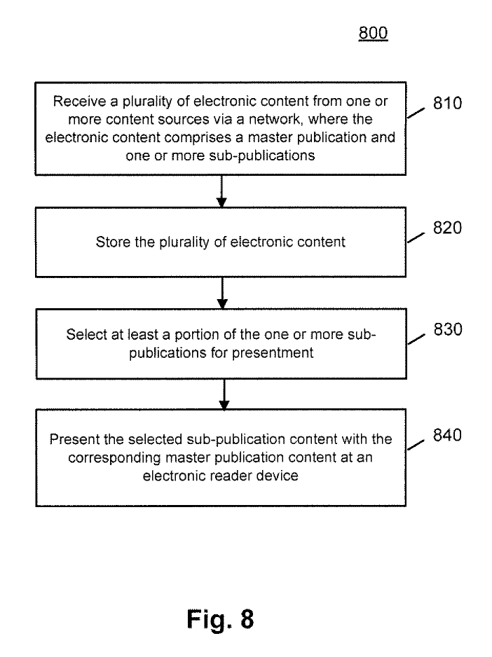

FIG. 8 depicts an illustrative flowchart for a method of presenting sub-publication content at an electronic device, according to an exemplary embodiment. The exemplary method 800 is provided by way of example, as there are a variety of ways to carry out methods disclosed herein. The method 800 shown in FIG. 8 may be executed or otherwise performed by one or a combination of various systems. The method 800 is described below as carried out by at least system 100 in FIG. 1 and/or module 200 in FIG. 2, by way of example, and various elements of system 100 are referenced in explaining the example method of FIG. 8. Each block shown in FIG. 8 represents one or more processes, methods, or subroutines carried in the exemplary method 800. A computer readable media comprising code to perform the acts of the method 800 may also be provided. Referring to FIG. 8, the exemplary method 800 may begin at block 810.

At block 810, an acquisition module may be configured to receive electronic content from one or more content sources via a network. The electronic content may include a master publication content and one or more sub-publication content. The sub-publication content may include a variety of content, such as news content, editorial content, book review content, sports content, classifieds content, and/or other newspaper/book related content. In some embodiments, the sub-publication content may include advertisement content.

At block 820, a storage module may be configured to store the plurality of electronic content. This may be achieved in one or more data storage units associated with the publication module 200.

At block 830, a selection module may be configured to select at least some of the one or more sub-publication content for presentation with the master publication content. This may be based on syntax similar to the ones described above. In some embodiments, the selection module may select the sub-publication content based on dimension (e.g., width and height). In other embodiments, the selection module selects the sub-publication content based on content association with the master publication (e.g., the sub-publication material is similar in content to that of the master publication). The sub-publication content may also include an automatic page turning feature when there are two or more pages of sub-publication content. It should be appreciated that the automatic page turning feature may also be designed to loop back to the first page when at the last page of the sub-publication or to terminate the automatic page turning feature when at the last page of the sub-publication.

The sub-publication content may also be updateable. For example, the selection module may be capable of selecting an update sub-publication content to replace any previously selected/presented sub-publication content, e.g., based on a time factor, user selection, etc.

At block 840, a presentation module may be configured to present the selected sub-publication content with the corresponding master publication content at an electronic reader device. In some embodiments, the presentation module 210 may fit the electronic content in an entire display portion of the electronic reader device. In other embodiments, the presentation module 210 may fit the electronic content in at least a display portion of the electronic reader device.

It should be appreciated that while embodiments are directed to presenting at least one sub-publication content, other various embodiments may also be provided.

While the features and functionalities the systems and methods are primarily directed to electronic publication content, it should be appreciated that the features and functionalities of may be applied to other content as well. Furthermore, while the publication content is described primarily in a visual display, it should be appreciated that the content may include multimedia, audio, and/or other presentments.

By delivering and presenting sub-publication content with master/parent publication content as described above, several advantages and benefits may be realized. First, since a sub-publication is essentially a publication, the same software used to create a master/parent publication may also be used to create the sub-publication. This may simplify the overall creation of sub-publication content.

Second, sub-publications may be just as rich in content as their master/parent counterparts. For example, sub-publications may contain multiple pages with links, images, and other features that a user of a reading device would expect from a general publication.

Third, sub-publications may be kept in pools delineated by their dimensions (e.g., width and height) as they would appear in their parent. In this example, a determination as to which sub-publication is to be to displayed may be left up to a reading device at render time. Therefore, this allows sub-publication content (e.g., advertisements or otherwise) to be dynamically refreshed without interaction with a server or other network component. It should be appreciated, however, that the sub-publication content may also be dynamically refreshed and/or updated through one or more interactions with a server or component over a network, such as the Internet.

Fourth, sub-publications may be optimized for their target reading device, just like their parent publication. Ultimately, such a targeting feature may further enhance a user's reading experience.

Fifth, each sub-publication may also be authored and/or debugged independent of the master/parent publication with which the sub-publication is contained. This may allow sub-publication sources (e.g., advertisers, etc.) to develop content independent of the master/parent publications. Not only does this provide flexibility in content publication but also efficiency in terms of content delivery.

Advantages in business and marketing strategies may also become increasingly apparent with use of the embodiments described herein. These benefits and opportunities may not otherwise be provided by conventional publication techniques in electronic devices.

In the preceding specification, various preferred embodiments have been described with references to the accompanying drawings. It will, however, be evident that various modifications and changes may be made thereto, and additional embodiments may be implemented, without departing from the broader scope of invention as set forth in the claims that follow. The specification and drawings are accordingly to be regarded in an illustrative rather than restrictive sense.

We claim:

1. A system for presenting sub-publication content in an electronic reader device, comprising:
an acquisition module configured to receive electronic content from one or more content sources via a network, wherein the electronic content comprises a master publication content item and one or more sub-publication content item;
a storage module configured to store the plurality of electronic content;
a selection module configured to select at least some of the one or more sub-publication content items for presentation with the master publication content; and
a presentation module configured to present the selected sub-publication content items with the corresponding master publication content at an electronic reader device.

2. The system of claim 1, wherein the sub-publication content items comprise at least one of news content, editorial content, book review content, sports content, classifieds content, book-related content, and newspaper-related content.

3. The system of claim 1, wherein the sub-publication content items comprise advertisement content.

4. The system of claim 1, wherein the selection module selects the sub-publication content item based on dimension.

5. The system of claim 1, wherein the selection module selects the sub-publication content items based on content association with the master publication.

6. The system of claim 1, wherein the sub-publication content item comprises two or more pages of content.

7. The system of claim 6, wherein the sub-publication content item comprises an automatic page turning feature.

8. The system of claim 1, wherein the automatic page turning feature is designed to loop back to the first page when at the last page of the sub-publication or to terminate the automatic page turning feature when at the last page of the sub-publication.

9. The system of claim 1, wherein the selection module is capable of selecting an update sub-publication content item to replace a previously selected the sub-publication content item.

10. A method for presenting sub-publication content in an electronic reader device, comprising:
receiving, at an acquisition module using at least one computer processor, electronic content from one or more content sources via a network, wherein the electronic content comprises a master publication content item and one or more sub-publication content items;
storing, at a storage module associated with the at least one computer processor, the plurality of electronic content;
selecting, by a selection module using the at least one computer processor, at least some of the one or more sub-publication content items for presentation with the master publication content item; and
presenting, by a presentation module using the at least one computer processor, the selected sub-publication content item with the corresponding master publication content item at an electronic reader device.

11. The method of claim 10, wherein the sub-publication content items comprise at least one of news content, editorial content, book review content, sports content, classifieds content, book-related content, and newspaper-related content.

12. The method of claim 10, wherein the sub-publication content items comprise advertisement content.

13. The method of claim 10, wherein the selection module selects the sub-publication content items based on dimension.

14. The method of claim 10, wherein the selection module selects the sub-publication content items based on content association with the master publication.

15. The method of claim 10, wherein the sub-publication content item comprises two or more pages of content.

16. The method of claim 6, wherein the sub-publication content item comprises an automatic page turning feature.

17. The method of claim 1, wherein the automatic page turning feature is designed to loop back to the first page when at the last page of the sub-publication or to terminate the automatic page turning feature when at the last page of the sub-publication.

18. The method of claim 1, wherein the selection module is capable of selecting an update sub-publication content item to replace a previously selected the sub-publication content item.

19. A computer readable medium comprising code to perform the acts of the method of claim 10.
